(19) United States
(12) Patent Application Publication
(10) Pub. No.: US 2005/0224240 A1
(43) Pub. Date: Oct. 13, 2005

(54) Fire detection and suppression apparatus

(76) Inventor: John James Cosgrove, County Kildare (IE)

Correspondence Address: HOFFMANN & BARON, LLP, 6900 JERICHO TURNPIKE, SYOSSET, NY, 11791, US

(21) Appl. No.: 10/506,265

(22) PCT Filed: Mar. 3, 2003
(86) PCT No.: PCT/IE03/00032

§ 371 Date: Aug. 31, 2004

(30) Foreign Application Priority Data
Mar. 1, 2002 (IE) S2002/0156

(51) Int. Cl. A62C 37/08

(52) U.S. Cl. 169/56; 169/37; 239/533.1; 239/209

(57) ABSTRACT

A fire detection and suppression apparatus includes an interface device (10) adapted to be mounted to a support surface A. The device (10) has an outer body (12), and an inner plunger (20) movable within the outer body (12) upon the supply of a pressurized fluid to open discharge outlets (13, 23) for the release of the pressurized fluid from the device. The plunger (20) is biased by a spring (21), to return to a closed position so as to close the discharge outlets (13, 23). The pressurized fluid is sufficient to overcome the spring (21) which can close the discharge outlets (13, 23) when the pressure of fluid drops below the force of the spring (21).

The present invention relates to apparatus for fire detection and fire suppression, including apparatus having one or more of the following functions, smoke detection, heat detection and water sprinkling which when activated releases water or other fluid into the space around the apparatus.

Fire detection and suppression apparatus are well known in the prior art but have major disadvantages when used in certain environments or situations where they may be vandalised or in certain scenarios where persons have been known to use sprinkler heads, heat detectors, smoke detectors and the like as a support for attaching ligatures for the purpose of harming themselves or other persons.

The object of the invention is to alleviate the above disadvantages.

The present invention provides a fire detection and suppression apparatus including an interface device adapted to be mounted to a support surface, the device including an outer body, and an inner portion movable within the outer body upon the supply of a pressurized fluid to open one or more discharge outlets for the release of the pressurized fluid from the device.

Advantageously, the inner portion comprises a plunger biased to return to a closed position so as to close the discharge outlets, the pressurized fluid being sufficient to overcome biasing means of the plunger with the biasing means being operable to close the discharge outlets when the pressure of fluid drops below the force of the biasing means.

Preferably, one or more of the discharge outlets are located on the outer body and the plunger acts to block the outlets when the plunger is in a closed position and one or more discharge outlets are located on the plunger and the outer body acts to block the outlets when the plunger is in a closed position.

Conveniently, a sampling pipe extends through the device to exit at a sampling orifice to enable air or smoke to be sampled for the purpose of heat and/or smoke detection.

Advantageously, the device includes means for transmitting a beam through the sampling pipe wherein the beam is operable to function as a detection means for smoke and/or proximity of persons.

Preferably, the device forms a sprinkler head adapted to be mounted to a ceiling or a wall.

The device can be manufactured from stainless steel, brass or any other suitable metal.

The pressurised fluid may be selected from the group comprising water, air, carbon dioxide, other fire suppression gas, and sedating gas.

The invention will hereinafter be more particularly described with reference to the accompanying drawings, which show by way of example only, three embodiments of a fire detection and suppression apparatus according to the invention. In the drawings:—

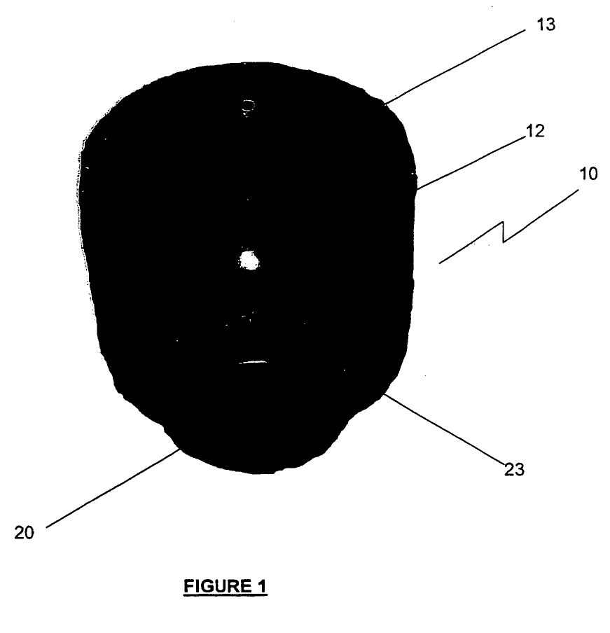

FIG. 1 is a perspective view of a first embodiment of the invention in an active mode;

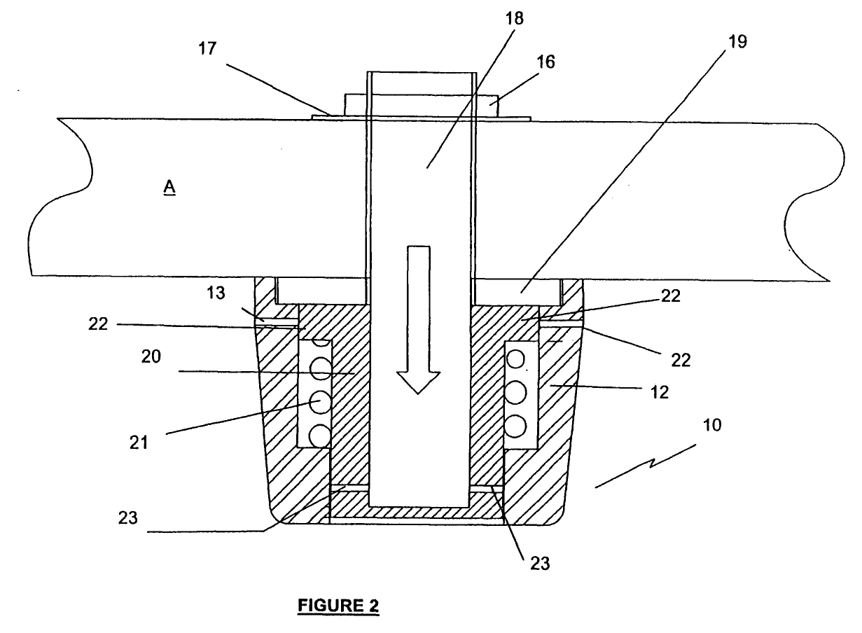

FIG. 2 is a cross-sectional side view through the first embodiment of the invention in a dormant mode;

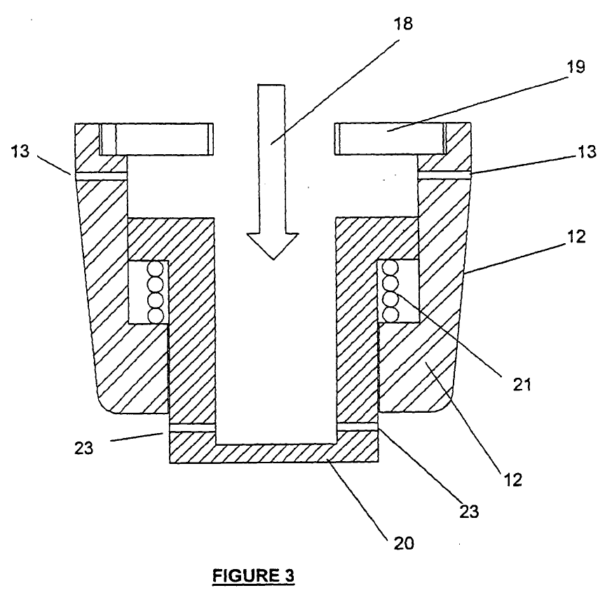

FIG. 3 is a cross-sectional side view through the first embodiment in an active mode;

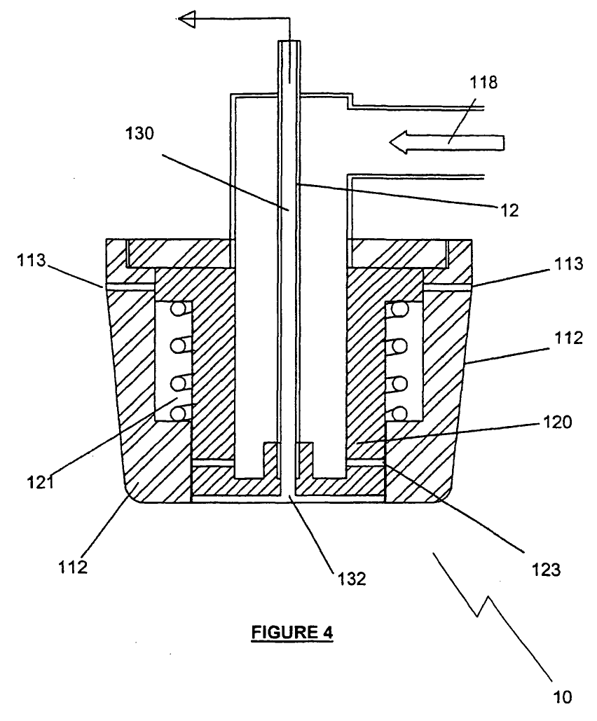

FIG. 4 is a cross-sectional side view through a second embodiment of the invention in a dormant mode;

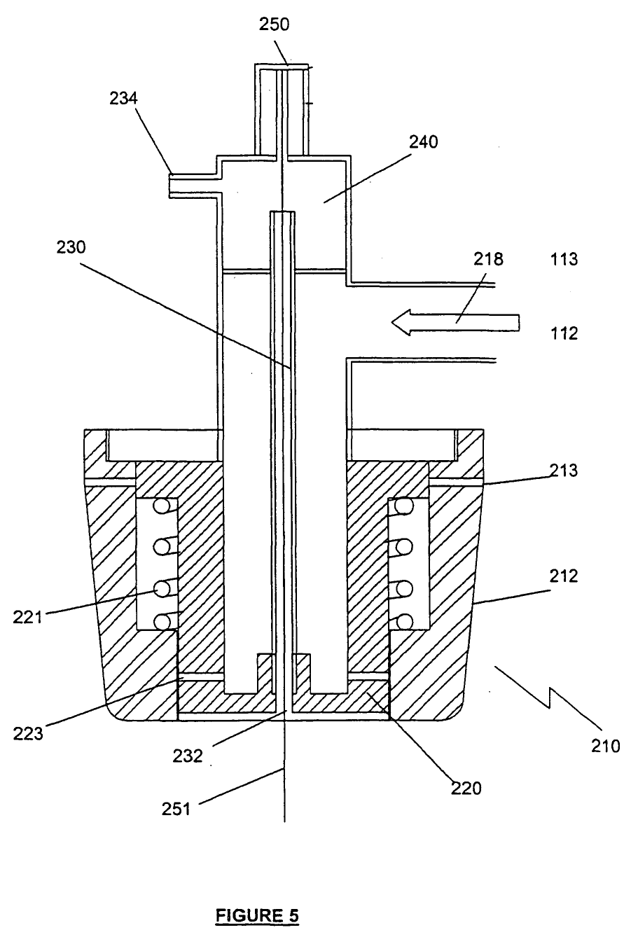

FIG. 5 is a cross-sectional side view through the second embodiment in an active mode;

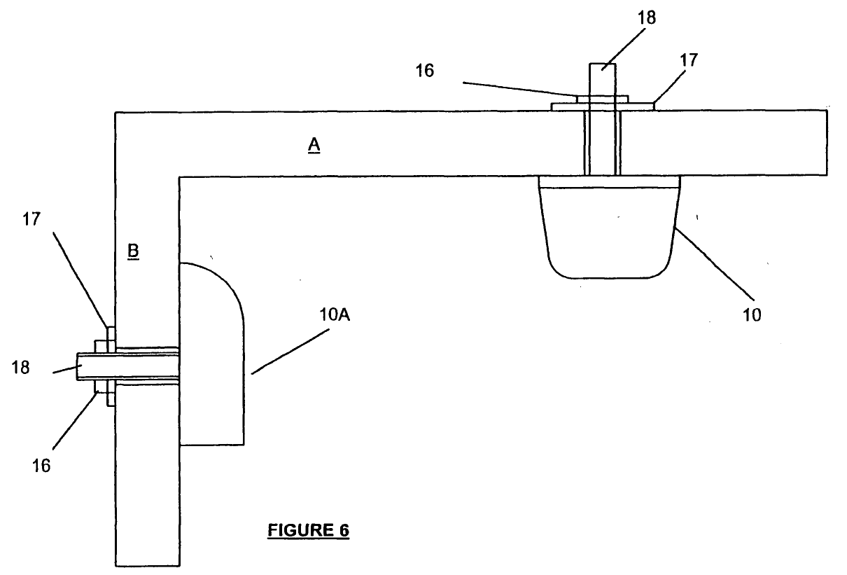

FIG. 6 is a cross-sectional side view through a third embodiment of the invention; and

FIG. 7 is a cross-sectional side view showing two possible arrangements for mounting a fire detection and suppression apparatus according to the invention in a location.

Referring to the drawings and initially to FIGS. 1 to 3, the first embodiment 10 of a fire detection and suppression apparatus according to the invention comprises an outer body 12 having a series of water outlets 13 on its outer surface mountable on a support surface A such as a ceiling or wall B by means of a lock nut 16 and retaining washer 17 secured against a backing plate 19 and fitted over a water inlet pipe 18 extending from the centre of the body 12. Contiguous to the water inlet pipe 18 is a spring biased plunger 20. In the dormant mode shown in FIG. 2, the water outlets 13 are covered by a collar 22 of the plunger 20. At the lower end of the plunger 20 is a further series of water outlets 23 which in the dormant mode are covered by the lower end of the outer body 12. Accordingly, no complete passageway is provided to allow water within the device to flow from it through outlets 13 or 23. Conversely no passageway is available to enable a ligature to be passed through for support or to allow access to the device.

When the device is activated as shown in FIG. 3, water pressure in the inlet pipe 18 released by means of a solenoid valve (not shown) forces the plunger to extend from the body 12 against the action of spring 21 until the springs are fully compressed. In that position the collar 22 is no longer blocking the water outlets 13 and water outlets 23 of the plunger are exposed thereby enabling the water in the device to flow so as to allow it to function as a water sprinkler.

The second embodiment 110 shown in FIG. 4 comprises an outer body 112, water outlets 113, plunger 120, spring 121 and water outlets 123 similar in function and structure to the corresponding features in the first embodiment 10. A water supply pipe 118 supplies water to the device. Extending up through the device is a small bore pipe 130 from a single small orifice 132 at the lower end of the plunger 120. The pipe 130 and orifice 132 together are used to deliver air from the space in which the device is located for air sampling and or smoke detection thereby enabling the second embodiment to function as a combined smoke detector and water sprinkler.

The third embodiment 210 shown in FIG. 5 comprises an outer body 212, water outlets 213, plunger 220, spring 221 and water outlets 223 similar in function and structure to the corresponding features in the first and second embodiments 10 and 110. A central chamber 240 is located within the plunger 220 and extends upwards therefrom. A water supply pipe 218 is connected to the central chamber 240 so that the pressurized water can force the plunger 220 downwards as in the first and second embodiments to open the water outlets 213 and 223.

A single orifice 232 at the lower end of the plunger 220 is connected to a small bore pipe 230 so that air can be taken through the orifice 232 and pipe 230 to deliver air through feed pipe 234 to a smoke sensor (not shown). Also, provided in the third embodiment 210 is a photoelectric proximity switch 250 which when in operation sends a beam 251 through the pipe 230 to a predetermined distance from the orifice 232. The primary function of the photoelectric proximity switch is to detect interference with the device if the beam is broken so that an alarm or signal may be activated. A secondary function is to identify smoke being ingested through the pipe 230. The third embodiment 210 thereby functions as a combined smoke detector, proximity detector and water sprinkler device.

Heat detector elements (not shown) can also be incorporated into the embodiments of the apparatus of the invention.

The apparatus of the invention is particularly suitable in providing fire safety in high security installations such as in cells and other areas in prisons, places of detention and correction, psychiatric institutions, strong rooms and store rooms for valuables and many other sites where fire safety and security are important considerations.

An independent air supply can be attached to the system between the solenoid valve of the water supply and the outlets for the purpose of undertaking dry tests to establish the mechanical functioning of the system and to establish that the various functional components are working.

Also the apparatus of the invention can be used to deliver different gases to an environment such as gases to starve a fire of oxygen or gases which would have a calming effect or sedate out of control inmates, patients or intruders.

It is to be understood that the invention is not limited to the specific details described herein which are given by way of example only and that various modifications and alterations are possible without departing from the scope of the invention as defined in the appended claims.

1. A fire detection and suppression apparatus including an interface device adapted to be mounted to a support surface, the device including an outer body, and an inner portion movable within the outer body upon the supply of a pressurized fluid to open one or more discharge outlets for the release of the pressurized fluid from the device.

2. A fire detection and suppression apparatus as claimed in claim 1, in which the inner portion comprises a plunger biased to return to a closed position so as to close the discharge outlets, the pressurized fluid being sufficient to overcome biasing means of the plunger with the biasing means being operable to close the discharge outlets when the pressure of fluid drops below the force of the biasing means.

3. A fire detection and suppression apparatus as claimed in claim 2, in which one or more of the discharge outlets are located on the outer body and in which the plunger acts to block the outlets when the plunger is in a closed position.

4. A fire detection and suppression apparatus as claimed in claim 3, in which one or more discharge outlets are located on the plunger and in which the outer body acts to block the outlets when the plunger is in a closed position.

5. A fire detection and suppression apparatus as claimed in claim 1, in which a sampling pipe extends through the device to exit at a sampling orifice to enable air or smoke to be sampled for the purpose of heat and/or smoke detection.

6. A fire detection and suppression apparatus as claimed in claim 5, including means for transmitting a beam through the sampling pipe wherein the beam is operable to function as a detection means for smoke and/or proximity of persons.

7. A fire detection and suppression apparatus as claimed in claim 1, in which the device forms a sprinkler head adapted to be mounted to a ceiling or a wall.

8. A fire detection and suppression apparatus as claimed in claim 1, which is manufactured from stainless steel, brass or any other suitable metal.

9. A fire detection and suppression apparatus as claimed in claim 1, in which the pressurised fluid is selected from the group comprising water, air, carbon dioxide, other fire suppression gas, and sedating gas.

10. (canceled)
